(19) United States
(12) Patent Application Publication
(10) Pub. No.: US 2015/0247778 A1
(43) Pub. Date: Sep. 3, 2015

(54) METHOD FOR MONITORING DAMAGE TO A SHAFT

(71) Applicants: Arno Haschke, Erlangen (DE); Hans-Henning Klos, Feucht (DE); Dirk Scheibner, Nuremberg (DE); Jürgen Schimmer, Nuremberg (DE)

(72) Inventors: Arno Haschke, Erlangen (DE); Hans-Henning Klos, Feucht (DE); Dirk Scheibner, Nuremberg (DE); Jürgen Schimmer, Nuremberg (DE)

(73) Assignee: SIEMENS AKTIENGESELLSCHAFT, München (DE)

(21) Appl. No.: 14/398,264

(22) PCT Filed: May 2, 2012
(86) PCT No.: PCT/EP2012/057999

§ 371 Date: Oct. 31, 2014

(51) Int. Cl. G01M 5/00; G01M 13/00

(52) U.S. Cl. CPC G01M 5/0033; G01M 5/0066; G01M 13/00

(57) ABSTRACT

At least one strain gauge is arranged on an outer surface of a shaft to monitor damage to the shaft. Deformation of the shaft is detected using measurement signal(s) from the at least one strain gauge and sound emissions of the shaft by evaluating the measurement signal(s) in the ultrasonic range.

### CROSS REFERENCE TO RELATED APPLICATIONS

This application is the U.S. national stage of International Application No. PCT/EP2012/057999, filed, May 2, 2012 and claims the benefit thereof. The International Application is incorporated herein in their entirety.

### BACKGROUND

Described below are a method for monitoring damage to a shaft and a device for monitoring damage to a shaft.

Shafts are used to transmit a force or a torque and are normally used in electric machines, gearboxes and bearing equipment. In order to avoid failure of these devices, the shaft should be monitored for damage which, for example, can arise as a result of the mechanical stressing of the shaft. In this way, overloading of the shaft and therefore potential breakage of the shaft can be prevented.

In order to be able to detect a loading of the shaft, it is usual nowadays for the torque acting on the shaft to be measured. For this purpose, strain gauges are attached or adhesively bonded to the outer surface of the shaft. The supply of power and the transfer of the measured data from the rotating shaft are carried out here either via slip rings or via telemetry. However, direct detection of the present damage to the shaft is generally not carried out.

### SUMMARY

Described below is a method that monitors the damage to a shaft more accurately in a simple way.

The method for monitoring damage to a shaft includes arranging at least one strain gauge on an outer surface of the shaft, detecting deformation of the shaft by using a measured signal from the at least one strain gauge, and detecting sound emissions from the shaft by evaluating the measured signal in the ultrasonic range.

Firstly, at least one strain gauge is arranged on the shaft or attached to the same. This can be done, for example, by using an appropriate special adhesive which deforms as little as possible under mechanical loading. The strain gauge can be arranged along the circumferential direction of the shaft, along the axial direction of the shaft or obliquely with respect thereto for this purpose. As a result of mechanical deformation of the shaft, the strain gauge is also deformed, as a result of which the electric resistance of the latter changes. The change in the electric resistance can be detected, for example, by using an appropriate measuring bridge.

By using the strain gauge, sound emissions which are generated in the shaft are additionally detected. The source of such sound emissions or stress waves is damage events in the shaft material. This phenomenon is also known under the term acoustic emission. These sound emissions, which are generated in the shaft and which form in the material of the shaft, are an indicator of continuous material damage, for example micro cracks. Thus, by using a strain gauge which is usually used for monitoring a torque acting on the shaft, sound emissions can additionally be detected. Therefore, progressive damage to the shaft can be determined in a simple way. Thus, it is not necessary for additional sensors to be used for detecting the damage to the shaft. Therefore, for the first time, in addition to the torque loading, the destruction of the material structure is also detectable. By using the at least one strain gauge, direct detection of crack formation on the shaft is therefore made possible, which means that an early warning can be enabled. Thus, unplanned stoppages can be avoided.

For the purposes of evaluation, the measured signal may be filtered by a band-pass filter in a frequency range from 80 to 150 kHz. The sound emissions or acoustic emission signals normally lie in the frequency range from 80 to 150 kHz. These frequencies are material-dependent. For example, frequencies of 110 kHz are typical of steel. In order to extract the signal components of these sound emissions from the measured signal from the strain gauge, band-pass filtering in the range of the characteristic frequency of the material of the shaft is provided. Here, electronic or digital filters can be used for the band-pass filtering of the measured signal. Thus, the sound emissions generated in the shaft can be detected in a simple way.

In a further embodiment, an envelope curve of the measured signal is determined in order to evaluate the measured signal. Such an envelope curve signal can be determined, for example, by rectification and low-pass filtering of the measured signals. By the envelope curve of the measured signal, simple evaluation of the measured signal is made possible.

The sound emissions may be detected as a function of time. In other words, the measured signal and the sound emissions detected in the measured signal are evaluated for so-called damage events. The characteristic value of the damage activity is the so-called event rate, that is to say the number of acoustic emission events per unit time. Thus, progressive crack formation in the shaft can be detected simply and reliably.

By using the measured signal, a torque acting on the shaft may be additionally determined, and the detected sound emissions are evaluated as a function of the torque acting on the shaft. In the case of a progressive shaft crack, the flexural rigidity of the shaft becomes position-dependent. This is increasingly manifested in the variation of the torque of the shaft. The sound emissions per unit time then primarily occur at maximum torque. In this way, the cause of the sound emissions or acoustic emission events can be classified. If a dependence of the sound emissions on the torque acting on the shaft occurs, then a growing crack in the shaft is probable as the cause. In this way, damage to the shaft, in particular crack formation, can be detected particularly reliably.

In a further refinement, the measured signal is additionally evaluated as a function of a temperature of the shaft. Sound emissions or acoustic emission can also arise in the event of thermal expansion of the material as a result of internal friction. Therefore, the temperature of the shaft should additionally be detected, in order to be sure that the acoustic emission signals can be used as an indicator of overloading of the shaft only in a thermally stable state. Therefore, damage to the shaft can be detected particularly reliably.

In a further embodiment, by using the measured signal, damage to a bearing coupled mechanically to the shaft is additionally detected, the measured signal being filtered with a band-pass filter in a frequency range from 30 to 50 kHz in order to detect the damage to the bearing. In addition to detecting cracks in the shaft, hard-coupled bearings, in particular the inner ring of the bearing, can also be monitored by evaluating the measured signal from the strain gauge. Existing damage can likewise be detected by using the measured signal if the measured signal is evaluated in a frequency range which lies below the frequencies of the sound emissions. For example, the measured signal from the strain gauge can be filtered in a range from 30 to 50 kHz, in particular in a frequency range around 40 kHz, for this purpose. This frequency depends on the material and the dimensions of the bearing. Therefore, by using a strain gauge which is arranged on the shaft, damage to a bearing coupled mechanically to the shaft can additionally be detected in a simple way. Therefore, monitoring of damage to further components which are connected or coupled mechanically to the shaft is also conceivable.

Here, in order to detect the damage to the bearing, the measured signal is evaluated as a function of a rotational speed of the shaft. If there is a relationship between the signal component from the measured signal which points to damage to the bearing and the rotational speed of the shaft, this can point to damage to the bearing. Therefore, damage to the bearing can be reliably determined.

The device for monitoring damage to a shaft includes at least one strain gauge, which can be attached to an outer surface of the shaft, so that deformation of the shaft can be detected by using the measured signal from the at least one strain gauge by detection component(s) designed to detect sound emissions from the shaft by evaluating the measured signal in the ultrasonic range.

The advantages and developments described previously in conjunction with the method apply in the same way to the device.

### BRIEF DESCRIPTION OF THE DRAWINGS

These and other aspects and advantages will become more apparent and more readily appreciated from the following description of the exemplary embodiments, taken in conjunction with the appended drawings of which:

FIG. 1 is a schematic block diagram of a device for monitoring damage to a shaft;

FIG. 2 is a graph of a measured signal from a strain gauge as a function of time;

FIG. 3 is a graph of a band-pass-filtered measured signal according to FIG. 2; and

FIG. 4 is a graph of an envelope curve signal of the measured signal according to FIG. 3.

### DETAILED DESCRIPTION OF THE PREFERRED EMBODIMENT

Reference will now be made to exemplary embodiments outlined in detail below which represent preferred embodiments illustrated in the accompanying drawings, wherein like reference numerals refer to like elements throughout.

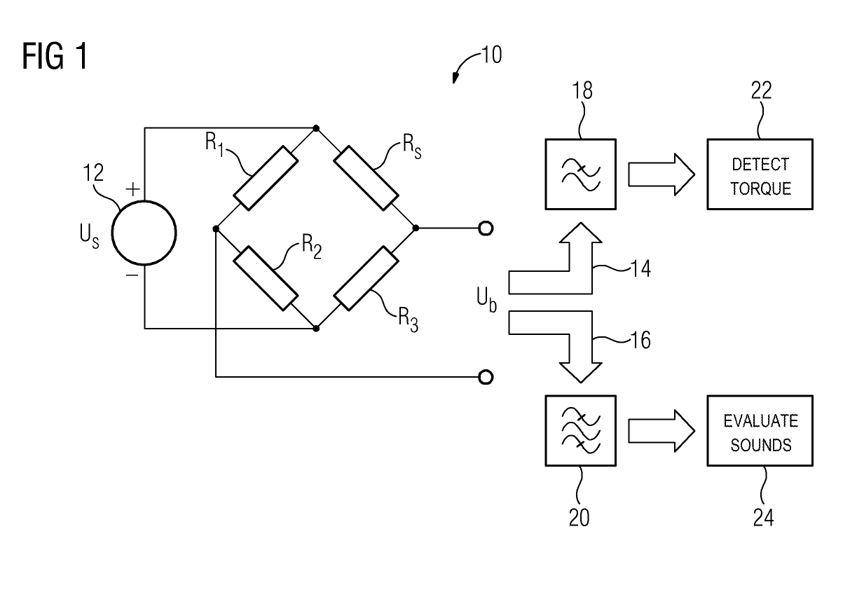

FIG. 1 shows a device 10 for monitoring damage to a shaft. The device 10 includes a strain gauge Rₛ which, in the present case, is constituted as an electric resistor. The strain gauge Rₛ is wired together with three further electric resistors R₁, R₂ and R₃ in accordance with a Wheatstone bridge. The bridge circuit is supplied with a supply voltage Uₛ from the voltage supply 12. The measured signal U_{b} from the strain gauge Rₛ can be tapped off as a bridge voltage from the measuring bridge.

Likewise, a plurality of strain gauges Rₛ can be arranged on the shaft, not illustrated here. The strain gauge Rₛ can be formed, for example, as a resistance wire on a film. The strain gauge Rₛ can be made from a metal or from a semiconductor. The strain gauge Rₛ may be attached to the outer surface of the shaft by using a special adhesive. As a result of mechanical deformation of the shaft, the strain gauge Rₛ is also deformed mechanically. As a result of the mechanical deformation, the electric resistance of the strain gauge Rₛ changes. The change in the electric resistance of the strain gauge Rₛ effects a change in the measured signal U_{b}.

In the present case, the measured signal U_{b} is divided. This is illustrated by the arrows 14 and 16. The high-frequency signal components of the measured signal U_{b} are damped by using a low-pass filter 18. The low-pass-filtered measured signal U_{b} is fed to a detection means 22. The detection means 22 is designed to detect the torque acting on the shaft as a function of the low-pass-filtered measured signal U_{b}. Furthermore, the measured signal U_{b} is band-pass filtered with a band-pass filter 20. Here, the measured signal U_{b} may be filtered in a frequency range from 80 to 150 kHz by using the band-pass filter 20. As a result of the band-pass filtering of the measured signal U_{b} in this frequency range, sound emissions in the shaft, which are also known under the designation acoustic emission, can be detected. The band-pass-filtered measured signal U_{b} is fed to a second detection means 24, with which the acoustic emission signals can be evaluated. The detection means 22 and 24 can likewise be formed as a common detection means.

FIG. 2 shows a first graph, in which amplitude of the measured signal U_{b} is illustrated as a function of the time t. Over the time variation of the measured signal U_{b}, low-frequency signal components, for example in the regions 26, and high-frequency signal components, for example in the regions 28, can be seen. The high-frequency signal components in the regions 28 are formed as a result of sound emissions from the shaft or acoustic emission signals in the shaft.

In order to be able to detect the high-frequency signal components, the measured signal U_{b} is filtered with the band-pass filter 20. For example, the measured signal U_{b} is band-pass filtered in the frequency range between 90 and 150 kHz. The band-pass-filtered measured signal U′_{b} is illustrated in FIG. 3. In the band-pass-filtered measured signal U′_{b}, only the high-frequency signal components in the regions 28 can still be seen. By using the band-pass-filtered measured signal U′_{b}, the sound emissions generated in the shaft can be detected simply. These sound emissions or acoustic emission signals can be an indication of continuing crack formation in the shaft.

FIG. 4 shows an envelope curve U″_{b} of the band-pass-filtered measured signal U′_{b} according to FIG. 3. By using the envelope curve U″_{b} of the measured signal U_{b} and of the band-pass-filtered measured signal U′_{b}, damage events can be detected in a simple way as a result of sound emissions. In addition, the so-called event rate, that is to say the number of acoustic emission events per unit time, can be detected in a simple way. These damage events can be detected simply in the envelope curve signal U″_{b}.

These are indicated in FIG. 4 by the arrows 30.

The measured signal U_{b}, the band-pass-filtered measured signal U′_{b} and the envelope curve U″_{b} can also be evaluated as a function of the torque, which is given by the low-pass-filtered measured signal U_{b}. Thus, cracks in the shaft can be detected particularly reliably. In addition to this, the temperature of the shaft can be taken into account when evaluating the measured signal U_{b}. For this purpose, for example, a suitable temperature sensor can be arranged on the shaft.

In addition to this, the measured signal U_{b} can be evaluated in a third frequency range, for example in a frequency range between 30 and 50 kHz. By using a measured signal U_{b} band-pass filtered in this frequency range, for example damage to a bearing coupled mechanically to the shaft can be detected. Thus, by using a strain gauge Rₛ, the torque acting on the shaft, sound emissions from the shaft and damage to an element coupled mechanically to the shaft can be detected.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for monitoring damage to a shaft, comprising:
arranging at least one strain gauge on an outer surface of the shaft;
detecting deformation of the shaft by using at least one measured signal from the at least one strain gauge; and
detecting sound emissions from the shaft by evaluating the at least one measured signal in an ultrasonic range.

11. The method as claimed in claim 10, further comprising filtering the at least one measured signal using a band-pass filter in a frequency range from 80 to 150 kHz prior to said detecting of the sound emissions.

12. The method as claimed in claim 11, further comprising determining an envelope curve of the at least one measured signal prior to said detecting of the sound emissions.

13. The method as claimed in claim 12, wherein said detecting of the sound emissions uses a function of time.

14. The method as claimed in claim 13,
further comprising determining a torque acting on the shaft using the at least one measured signal, and
wherein said detecting of the sound emissions uses a function of the torque acting on the shaft.

15. The method as claimed in claim 14, wherein said detecting of the sound emissions uses a function of a temperature of the shaft.

16. The method as claimed in claim 15, further comprising:
filtering the at least one measured signal using a band-pass filter in a frequency range from 30 to 50 kHz to produce a filtered signal; and
detecting damage to a bearing coupled mechanically to the shaft based on the filtered signal.

17. The method as claimed in claim 6, wherein said detecting damage to the bearing uses a function of a rotational speed of the shaft.

18. The method as claimed in claim 10, further comprising determining an envelope curve of the at least one measured signal prior to said detecting of the sound emissions.

19. The method as claimed in claim 10, wherein said detecting of the sound emissions uses a function of time.

20. The method as claimed in claim 10,
further comprising determining a torque acting on the shaft using the at least one measured signal, and
wherein said detecting of the sound emissions uses a function of the torque acting on the shaft.

21. The method as claimed in claim 10, wherein said detecting of the sound emissions uses a function of a temperature of the shaft.

22. The method as claimed in claim 10, further comprising:
filtering the at least one measured signal using a band-pass filter in a frequency range from 30 to 50 kHz to produce a filtered signal; and
detecting damage to a bearing coupled mechanically to the shaft based on the filtered signal.

23. The method as claimed in claim 22, wherein said detecting damage to the bearing uses a function of a rotational speed of the shaft.

24. A device for monitoring damage to a shaft, comprising:
at least one strain gauge, attached to an outer surface of the shaft, producing a measured signal;
deformation detection means, coupled to the at least one strain gauge, for detecting deformation of the shaft using the measured signal; and
sound detection means for detecting sound emissions from the shaft by evaluating the measured signal in the ultrasonic range.
